(19) United States
(12) Patent Application Publication
(10) Pub. No.: US 2015/0112792 A1
(43) Pub. Date: Apr. 23, 2015

(54) SYSTEM AND METHOD FOR PROVIDING USER INFORMATION FOR CUSTOMIZED CONTENT PROVISION SERVICE

(71) Applicant: Ki Jeoung Kim, Seoul (KR)

(72) Inventor: Ki Jeoung Kim, Seoul (KR)

(21) Appl. No.: 14/390,224

(22) PCT Filed: Feb. 14, 2013
(86) PCT No.: PCT/KR2013/001151

§ 371 Date: Oct. 2, 2014

(30) Foreign Application Priority Data
Apr. 5, 2012 (KR) 10-2012-0035402

(51) Int. Cl. G06Q 30/02; G06Q 20/12

(52) U.S. Cl. CPC G06Q 30/0256; G06Q 30/0258; G06Q 30/0261; G06Q 30/0242; G06Q 20/127
USPC 705/14.41; 705/14.54

(57) ABSTRACT

The present invention relates to a system and method for providing user information for a customized content provision service which enables a content distributor to collect action plans of the past, present, and future established by users and to use the collected action plans during a search for a target user. According to the present invention, there is no need to collect personal information on the users to predict the future actions of the users. Therefore, the invention is effective at protecting the privacy of the users and improving the accuracy and reliability of the customized content provision service.

### TECHNICAL FIELD

Disclosed herein is a user data service system and a user data service method for a personalized contents providing service. Particularly, the personalized contents providing service collects past, present, and future action plans established by a user, for a contents distributor to utilize the plans at the time of target user searching.

### BACKGROUND ART

Nowadays, the personalized contents providing service provides contents such as various kinds of information and advertisings suitable for the user through a communication terminal carried by the user. For example, in Patent Document 1, a personalized contents providing service of providing advertisings suitable for a mobile phone carrier is disclosed.

Recently, a personalized contents providing service appears, which share data of predicting future action of users and lets contents providers contents provide users with appropriate contents relating to the future action of the users.

Such a personalized contents providing service is as follows. Generally, when a user joins a service, personal data of the user is collected in a server through a communication terminal carried by the user. Thereafter, the terminal use information is collected in real time from the communication terminal, it is confirmed whenever, wherever, and whatever the user does on the basis of the collected terminal use information, and the terminal recognize an action pattern of the user. Then, a database of the future action of the user predicted on the basis of the personal data of the user and the action pattern of the user is constructed in the server. Accordingly, the contents distributor searches a user who will perform the future action specified through the database, and may select the user as a target for contents distribution. The contents distributor provides the contents relating to the future action specified through the communication terminal carried by the user selected as the target, for the user.

The personal data of the user includes real name, resident registration number, social security number, home and workplace contact number, home and workplace address and e-mail address, and the like. The terminal use information includes recording data such as an address book, phone call records, message sending and receiving records stored in the communication terminal, a real-time position of the communication terminal, a driving history of the communication terminal based on position/location and time, internet access/search/shopping/payment history through the communication terminal, and the like.

However, in the related art, since at the time of constructing the database for target user search, personal data of the user at the time of joining the service of the user is necessarily collected to predict the future action of the user, the personal data of the user may be leaked out or indiscreetly abused for the other purpose by hacking of the server or a server manager, and thus there is a problem that a private life of the user may be seriously threaten.

In addition, in the related art, although it is difficult to guarantee that the user necessarily perform the predicted future action, the contents providers provide user who are selected as a target after searching database with the contents relating to the predicted future action of the user, thus there is a problem that accuracy and reliability of the personalized contents providing service are decreased.

### DOCUMENT OF RELATED ART

Korean Patent Publication No. 1020080037331 A

### DISCLOSURE

### Technical Problem

The present disclosure has been made to solve the problems described above, and an object disclosed herein is to provide a user data service system and method for a personalized contents providing service, in which past, present, and further action plans established by a user are collected such that a contents distributor utilize them at the time of target user search.

### Technical Solution

To achieve the objected described above, according to an aspect disclosed herein, there is provided a user data service system for a personalized contents providing service including: a server for collecting user certification information and action plans of a user through a communication terminal, and analyzing the collected action plans of the user to generate a unique attribute; a DB group in which the action plans of the user matched with the user certification information and the unique attribute of the user are stored; and an application program module, which is provided in the communication terminal, for acquiring the action plans of the user, providing the action plans together with the user certification information to the server, and searching a target user for contents distribution through the searching of the DB group.

According to another aspect disclosed herein, there is provided a user data service method for a personalized contents providing service including: storing user certification information and action plans of a user in a DB group, the user certification information and the action plans of the user are collected from an application program module provided in a communication terminal and matched with each other by server; storing a unique attribute of the user in the DB group, the unique attribute of the user is generated through analysis of the action plans of the user stored in the DB group and matched to the user certification information by the server; searching, by the application program module, a target user for contents distributor through the searching of the DB group.

### Advantageous Effects

According to the user data service system for the personalized contents providing service disclosed herein, past, present, and future action plans established by a user are collected such that a contents distributor utilizes the collected action plans at the time of target user searching, and thus it is not necessary to collect the personal data of the user to predict the future action of the user, and there are advantages that it is possible to protect a private life of the user and it is possible to improve accuracy and reliability of the personalized contents providing service.

### DESCRIPTION OF DRAWINGS

FIG. 1 is a configuration diagram schematically illustrating a configuration of a user data service system for a personalized contents providing service according to an embodiment disclosed herein;

FIG. 2 is a configuration diagram schematically illustrating a configuration of a communication terminal in FIG. 1;

FIG. 3 is a configuration diagram schematically illustrating a configuration of an application program module in FIG. 2;

FIG. 4 is a flowchart sequentially illustrating a user data service method for a personalized contents providing service according to the embodiment disclosed herein;

FIG. 5 is a flowchart sequentially illustrating a flow of constructing a DB group in FIG. 4.

Description of Reference Numerals

| | |
|---|---|
| 10: COMMUNICATION TERMINAL | 11: INPUT MODULE |
| 12: DISPLAY MODULE | 13: SOUND MODULE |
| 14: POSITION ACQUIRING MODULE | |
| 15: COMMUNICATION SUBSCRIBER | |
| IDENTIFYING MODULE | |
| 16: APPLICATION PROGRAM MODULE | |
| 20: DB GROUP | 21: ACTION DB |
| 22: PLAN PERFORMANCE DB | 23: ATTRIBUTE DB |
| 24: POSITION DB | 25: RELIABILITY DB |
| 26: STATE DB | 30: SERVER |
| 40: COMMUNICATION NETWORK | |

### MODE FOR INVENTION

Hereinafter, a user data service system and method for a personalized contents providing service according to embodiments of the present disclosure will be described with reference to the accompanying drawings.

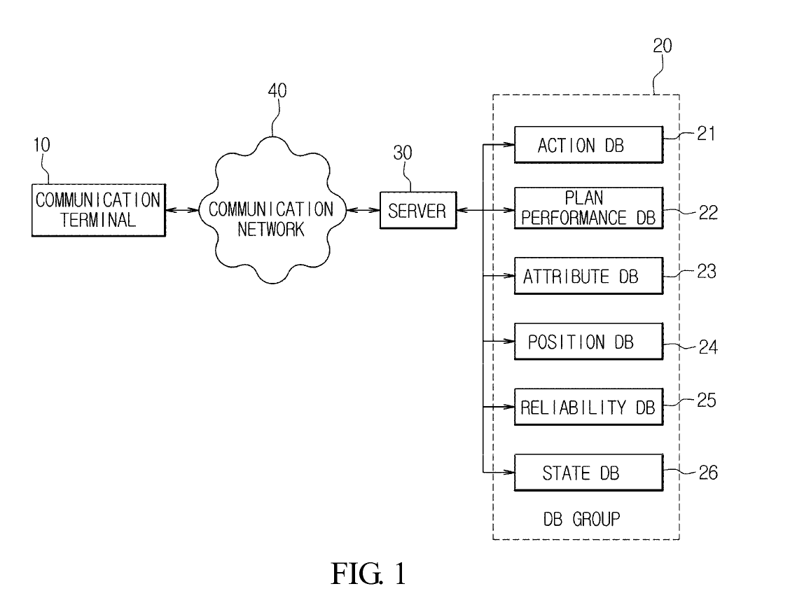

Referring to FIG. 1, the user data service system for the personalized contents providing service according to an embodiment of the present disclosure includes a communication terminal 10, a DB (DataBase) group 20, and a server 30. The communication terminal 10 and the server 30 are connected to each other through a communication network 40, and the DB group 20 is provided in the server 30 or separated from the server 30 to perform wire or wireless communication. For example, the communication network 40 may includes various networks such as a mobile communication network, a wireless LAN based on Wi-Fi, and an internet.

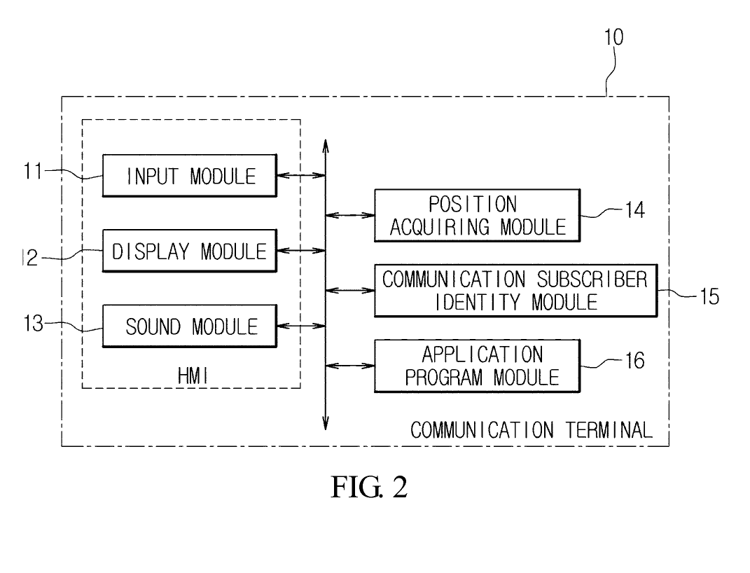

Referring to FIG. 2, the communication terminal 10 has Human Machine Interface (HMI) comprising an input module 11 for inputting information such as a keypad and a button, a display module 12 for displaying information and a sound module 13 for outputting sound, a position acquiring module 14 that acquires user position information for each time using a real-time position of the communication terminal 10 measured through Global Positioning System (GPS), a communication subscriber identity module (for example, SIM or USIM) 15, an application program module 16, and various applications, etc. For example, the communication terminal 10 may be formed of a mobile communication terminal such as a smart phone, a tablet PC, or a smart pad, an IPTV, a computer, or the like.

When a plan management event happens by an input of the user through the HMI, the application program module 16 provides a plan management UI for an action plan input, change, and the like through the HMI. For example, the application module 16 may be embodied in a form of application, and may be provided in the communication terminal 10.

In addition, the application program module 16 acquires and stores past, present, and future action plans according to the user input through the plan management UI. In this case, the application program module 16 may are equipped with the communication terminal 10 and acquire the action plans of the user in cooperation with morning call/alarm/schedule applications in which the action plans are stored.

The action plan may include plan performance date and time, a plan performance determination reference, a plan content, and the like. In this case, the plan performance determination reference may be formed of a specific place, a URL of a specific web side, and a specific media watching channel for performing the plan. The plan content may include a noun representing a schedule, an event, and the like, and a verb of the past, present, and future tenses. For example, the action plan may be formed of combination of a numeral and a symbol meaning the plan performance date and time, the plan performance determination reference, and the plan content, or an encoded code such as a code.

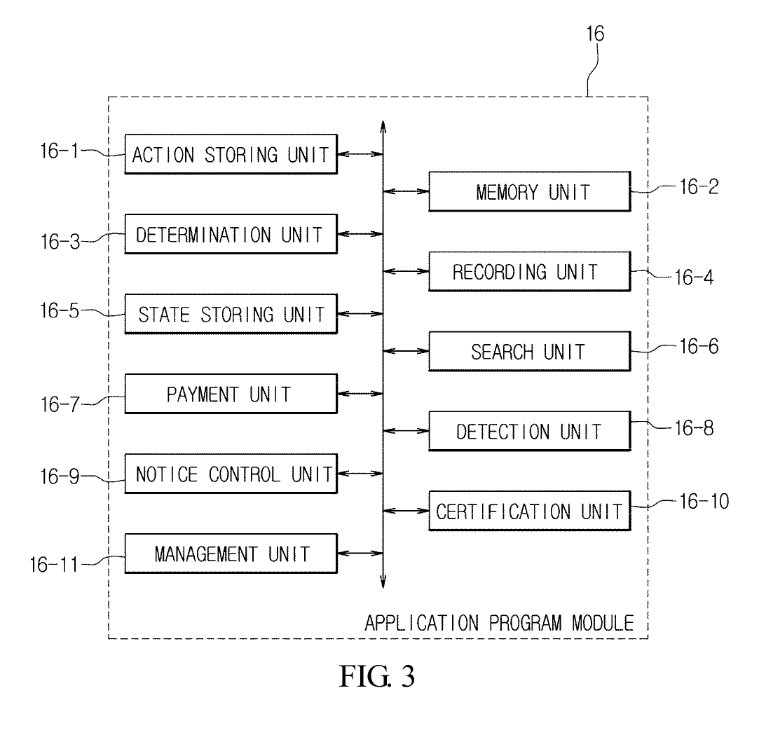

As shown in FIG. 3, the application program module 16 may include an action storing unit 16-1 that stores action plans of the user, a memory unit 16-2 that memorizes a plan change content for each action plan stored in the action storing unit 16-1, a determination unit 16-3 that determines plan performance or nonperformance for to each action plan stored in the action storing unit 16-1, and a recording unit 16-4 that records plan performance or nonperformance for each action plan determined by the determination unit 16-3. Herein, the plan change content may include plan change data and time, and a plan change content (for example, plan delay and plan abandonment).

The action storing unit 16-1 may classify and store the action plans for each category according to kinds of action and events of the user.

For example, when the plan performance determination reference included in the action plan stored in the action storing unit 16-1 is a specific place, the determination unit 16-3 may confirm whether or not the user of the communication terminal 10 is positioned at the time and place corresponding to the plan performance date and time and the specific place included in the action plan stored in the action storing unit 16-1, using the user position information for each time acquired by the position acquiring module 14, and determine the plan performance or nonperformance of the user for each action plan stored in the action storing unit 16-1 according to the confirmation result. In this case, when the user is positioned at the time and place corresponding to the plan performance date and time and the specific place included in the action plan stored in the action storing unit 16-1, the determination unit 16-3 may further confirm whether or not a specific barcode or a specific QR code is scanned, a specific RF signal is read, or a specific infrared signal is sensed, in cooperation with a code scan application, an RF reader application, or an infrared sensor application provided in the communication terminal 10, and determine the plan performance or nonperformance of the user for each action plan stored in the action storing unit 16-1 according to the confirmation result.

In addition, when the plan performance determination reference included in the action plan stored in the action storing unit 16-1 is the URL/specific media watching channel of the specific web site, the determination unit 16-3 confirms whether or not a web browser/media player application access the URL/specific media watching channel of the specific web site at the time corresponding to the plan performance date and time included in the action plan stored in the action storing unit 16-1, in cooperation with the web browser/media player application provided in the communication terminal 10, and may determine the plan performance or nonperformance of the user for each action plan stored in the action storing unit 16-1 according to the confirmation result. Herein, the media player application may be a Digital Multimedia Broadcasting (DMB) player application or the like.

In addition, the application program module 16 may acquire and store at least any one of a user feeling state, a user physical state, and an external environmental state for each date. For example, the application program module 16 acquires the user feeling state classified into happiness, anger, sorrow, and pressure through data of the user directly input through the HMI of the communication terminal 10, for each date, and acquires the user physical state (biorhythm) classified into high, intermediate, and low for each date in cooperation with the server 30. The application program module 16 accesses the meteorological office web server and the national statistical office on the communication network 40 through the communication terminal 10, and acquires the external environmental state including weather, temperature, discomfort index, economic misery index, and the like, for each date.

The application program module 16 may further include a state storing unit 16-5 that acquire and stores at least any one of the user feeling state, the user physical state, and the external environmental state for each date.

Meanwhile, when a target search event happens according to the input of the user through the HMI of the communication terminal 10, the application program module 16 provides a target searching UI for searching and selecting a target user through the HMI of the communication terminal 10. In this case, the application program module 16 requests the server 30 to search the target user when the target search event happens. When the server permits the target user searching, the application program module 16 may provide the target searching UI through the HMI of the communication terminal 10.

The application program module 16 may further include a search unit 16-6 that searches users satisfying the set target search option in the DB group 20 and displays the number or a list of searched users through the target searching UI, when the target search option is set by the input of the user through the target searching UI. In this case, the search unit 16-6 may classify and search the users for categories according to the target search option. Herein, the target search option may include a unique attribute, an action plan, plan performance reliability, and the like of the user. The unique attribute of the user may include a residence country, a residence region, an action region, an age, a sex, a birthday, a scholarship, a religion, an occupation, an exercise amount, favorite goods, interests, a social network, family, and the like of the user.

For example, when the target search option is set, the search unit 16-6 searches user certification information satisfying the set target search option, in the DB group 20 and may display the number of searched user certification information as the number of users through the target search UI. Herein, the user certification information may include at least one of, for example, a production serial number of the communication terminal 10, a unique number (application identification) of the application program module 16 provided in the communication terminal 10, a unique number of the communication subscriber identity module 15.

When the target search option is set, the search unit 16-6 searches user certification information satisfying the set target search option, in the DB group 20 and encodes the searched user certification information and converts it into a user identity code, and then displays a list of the converted user identity code as a list of the user through the target searching UI. In addition, the search unit 16-6 searches the plan performance reliability matched with the user certification information corresponding to the user identity code, in the DB group 20, and displays the plan performance reliability together with the user identity code through the target searching UI. Herein, the user identity code may be formed of a numeral or a character representing sequence.

In addition, when any one user for detailed search is selected by the input of the user through the target searching UI, from the list of the users displayed through the target searching UI, the search unit 16-6 may perform the search of the DB group 20 using the user certification information corresponding to the selected user and search the unique attribute of the user, the plan performance reliability, the action plans, the plan performance or nonperformance for each action plan, the plan change content, and the user feeling state, the user physical state, and the external environmental state of the plan performance date and the plan change date for each action plan, and may display the search result through the target searching UI.

Thereafter, the search unit 16-6 may sort the action plans on the basis of the plan performance or nonperformance and the plan change content by the input of the user through the target searching UI, and may display the action plans through the target searching UI. In addition, the search unit 16-6 may classify the displayed action plans on the basis of at least any one of the user feeling state, the user physical state, and environmental state of the plan performance date and the plan change date, and may display the action plans through the target searching UI.

In addition, the search unit 16-6 may select the user selected by the input of the user through the target searching UI as a target user for contents distribution, from the list of the users displayed through the target searching UI.

In addition, the application program module 16 may further include a payment unit 16-7 that provides a payment service environment between the user and the server 30 through the HMI when the application program module 16 is requested for payment from the server 30. For example, the payment unit 16-7 may be formed of a virtual machine for mobile payment.

In addition, the application program module 16 may further include a detection unit 16-8 and a notice control unit 16-9, wherein the detection unit 16-8 detects the action plans including the plan performance date and time corresponding to the present date and time in real time, among the action plans stored in the action storing unit 16-1 and the notice control unit 19-9 outputs, through HMI, a notice message and a notice sound for notifying that the performance time of the detected action plan gets close when the action plan including the plan performance date and time corresponding to the present date and time is detected by the detection unit 16-8.

The notice control unit 16-9 may provide the push notice for inducing the input of the action plan in irregular or regular time/place, to the user through HMI. In this case, the push notice may be output in a form of voice or popup message through the HMI of the communication terminal 10.

In addition, the application program module 16 may further include a certification unit 16-10 that performs a subscriber certification procedure in a relationship with the server 30 by requesting the server 30 for subscriber certification when a subscriber certification event happens by the input of the user through the plan management UI.

In addition, the application program module 16 may further include a management unit 16-11 that registers the action plans of the user stored in the action storing unit 16-1, in the DB group 20, or downloads the action plans of the user stored in the DB group 20 to the action storing unit 16-1, according to the control of the server 30, by requesting the server 30 for action registration/download, when an action registration/download event happens by the input of the user through the HMI.

Meanwhile, the DB group 20 may include an action DB 21 that stores the action plans matched with the user certification information, a plan performance DB 22 that stores the plan performance or nonperformance for each action plan matched with the user certification information and the plan change content, an attribute DB 23 that stores a unique attribute of the user matched with the user certification information, a position DB 24 that stores the user position information for each time matched with the user certification information, a reliability DB 25 that stores plan performance reliability matched with the user certification information, and a state DB 26 that stores at least any one of the user feeling state, the user physical state, and the external environmental state of the plan performance date and the plan change date for each action plan matched with the user certification information.

The action DB 21 may classify and store the action plans for each category according to kinds of action and events of the user.

Meanwhile, when the server 30 is requested for subscriber certification from the application program module 16, the server 30 performs a subscriber certification procedure for confirming whether or not the user (hereinafter, referred to as ‘user of application program module’) of the communication terminal 10 provided with the application program module 16 requesting the subscriber certification is a subscriber, and reports success or failure in subscriber certification to the application program module 16.

At the time of the subscriber certification procedure, the server 30 acquires a plurality of action plans from the application program module 16 requesting the subscriber certification, and searches the user certification information commonly matched with the acquired action plans, in the action DB 211, and determines that it succeeds in the subscriber certification when single user certification information is detected as the search result, and reports the success in subscriber certification to the application program module 16 requesting the subscriber certification, and designates the detected single user certification information as the user existing certification information which has been used by the user of the application program module 16.

In this case, the server 30 acquires the action plan from the application program module 16 requesting the subscriber certification, and searches the user certification information matched with the acquired action plan, and stores the searched user certification information in an internal memory area. Thereafter, the server 30 confirms whether or not the number of user certification information stored in the internal memory area is single, and acquires additionally the action plan from the application program module 16 when the number of user certification information is not single, and searches the user certification information matched with the additionally acquired action plan in the action DB 21, and then deletes the user certification information different from the searched user certification information, from the internal memory area. Meanwhile, when the number of user certification information stored in the internal memory area is single, the server 30 designates the single user certification information as the user existing certification information. Thereafter, the server 30 changes the user existing certification information designated in the DB group 20 to the user certification information acquired from the application program module 16 requesting the subscriber certification.

In addition, at the time of the subscriber certification procedure, the server 30 acquires a plurality of action plans from the application program module 16 requesting the subscriber certification, and searches the user certification information commonly matched with the acquired action plans, in the action DB 21, and determines that it fails in the subscriber certification when the single user certification information is not detected as the search result, and reports the failure in the subscriber certification to the application program module 16.

In addition, when the server 30 is requested for action registration from the application program module 16, the server 30 collects the user certification information and the action plans of the user from the application program module 16, matches them with each other, and stores them in the action DB 21.

In addition, when the server 30 is requested for action download from the application program module 16, the server 30 performs a subscriber certification procedure for confirming whether or not the user of the application program module 16 is a subscriber, and acquires the user certification information from the application program module 16 when it succeeds in the subscriber certification, and searches the action plans matched with the acquired user certification information in the action DB 21, and stores the action plans searched in the application program module 16.

In addition, the server 30 may receive, from the application program module 16, the plan change content for each action plan which is matched with the user certification information stored in the action DB 21, and store the plan change content in the plan performance DB 22 of the DB group 20.

In addition, the server 30 may determine the plan performance or nonperformance of the user for each action plan which is matched with the user certification information stored in the action DB 21, and match the determined plan performance or nonperformance with the user certification information, and store the plan performance or nonperformance in the plan performance DB 22 of the DB group 20.

When the plan performance determination reference include in the action plan is a specific place, the server 30 may confirm whether or not the user of the application program module 16 is positioned at the time and place corresponding to the plan performance date and time and the specific place included in the action plan stored in the action DB 21, using the user position information for each time matched with the user certification information stored in the position DB 24, and determine the plan performance or nonperformance of the user for each action plan stored in the action DB 21 according to the confirmation result. When the user is positioned at the time and place corresponding to the plan performance date and time and the specific place included in the action plan, the server 30 further confirms whether or not a specific barcode and a specific QR code is scanned, a specific RF signal is read, or a specific infrared signal is sensed, in cooperation with a code scan application, an RF reader application, or an infrared sensor application provided in the communication terminal 10, and the server 30 may determine the plan performance or nonperformance of the user for each action plan stored in the action DB 21 of DB group 20 according to the confirmation result.

In addition, when the plan performance determination reference included in the action plan is a URL/specific media watching channel of a specific web site, the server 30 may confirm whether or not a web browser/media player application accesses the URL/specific media watching channel of the specific web site at the time corresponding to the plan performance date and time included in the action plan stored in the action DB 21 in cooperation with the web browser/media player application provided in the communication terminal 10, and determine the plan performance or nonperformance of the user for the action plan of the action DB 21 according to the confirmation result.

In addition, the server 30 acquires and matches all of the user certification information, the performance or nonperformance for each action plan, and the plan change content, and then may store the user certification information, the performance or nonperformance for each action plan, and the plan change content in the plan performance DB 22 of the DB group 20.

In addition, the server 30 may analyze the action plans matched with the user certification information stored in the action DB 21, and recognize a life pattern of the user corresponding to the user certification information, and estimate and generate the unique attribute (for example, user profile excluding personal data) on the basis of the recognized life pattern of the user, and match the generated unique attribute with the user certification information, and store the unique attribute in the attribute DB 23. Then, the server 30 may perform repetitive analysis according to the date and time and the place of each action plan matched with the user certification information stored in the action DB 21, and recognize the life pattern of the user through such repetitive analysis, and estimate and generate the unique attribute of the user on the basis of the recognized life pattern.

In addition, the server 30 analyzes the user biorhythm for each date using the birthday of the user in the unique attribute of the user according to the request of the application program module 16, and provides the user biorhythm as the user physical state to the application program module 16. In this case, the server 30 may be provided with an application program capable of analyzing a biorhythm of a birthday person using the birthday.

In addition, the server 30 acquires the user certification information and the user position information for each time from the application program module 16, matches them with each other, and stores them in the position DB 24. In this case, the server 30 recognizes the position of the communication terminal 10 provided with the application program module 16 in real time through a mobile communication network constituting the communication network 40.

In addition, the server 30 may search, in the plan performance DB 22, the plan change content and the plan performance or nonperformance for each action plan which is matched with the user certification information stored in the action DB 21, and calculate the plan performance reliability of the user on the basis of the plan performance or nonperformance and the plan change content for each searched action plan, and match the calculated plan performance reliability with the user certification information, and stores the plan performance reliability in the reliability DB 25. Herein, the plan performance reliability may include a plan performance ratio and a plan change ratio. In addition, the plan performance ratio and the plan change ratio may be calculated for a time unit such as year, month, week, and date.

In addition, the server 30 searches the plan performance or nonperformance and the plan change content of each action plan matched with the user certification information stored in the action DB 21, in the plan performance DB 22, and confirms the plan performance data and the plan change date for each action plan using the plan performance or nonperformance and the plan change content of each searched action plan, and the server 30 acquires at least any one of the user feeling state, the user physical state, and the external environmental state of the plan performance date and the plan change date for each confirmed action plan in cooperation with the application program module 16, matches it with the user certification information, and stores it in the state DB 26 of DB group 20.

In addition, when the server 30 is requested for target user search from the application program module 16, the server 30 requests the application program module 16 for payment, and performs a payment procedure with the application program module 16. When the payment procedure is completed, the server 30 permits the target user search.

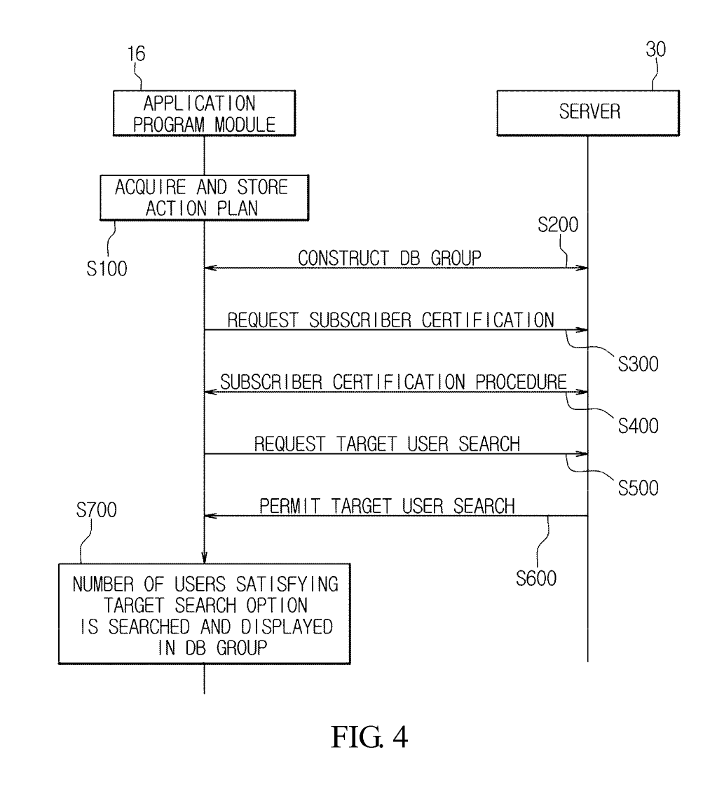

Hereinafter, the user data service method for the personalized contents providing service according to an embodiment of the present disclosure will be described with reference to FIG. 4.

First, the application program module 16 provided in the communication terminal 10 acquires the action plan of the user, and stores the action plan therein (S100).

In S100, the application program module 16 provides the push notice for inducing the user to input the action plan for each irregular or regular time/place through the HMI. Thereafter, the application program module 16 may receive an input of only the future action plan from the user or receive all of the past, present and future action plans, and may store them therein.

In S100, the action plan may include the plan performance date and time, the plan performance determination reference, and the plan content. For example, the plan performance determination reference may be formed of a specific place, a URL of a specific web site, or a specific media watching channel for performing the plan. The plan content may include a noun representing a schedule, an event, and the like, and a verb of the past, present, and future tenses. For example, the action plan may be formed of combination of a numeral and a symbol meaning the plan performance date and time, the plan performance determination reference, and the plan content, or an encoded code such as a code.

After S100, the server 30 collects the user certification information and the action plans of the user from the application program module 16, and constructs the DB group 20 for target user search (S200).

For example, the user certification information in S200 may include at least one of a production serial number of the communication terminal 10, a unique number (application identification) of the application program module 16 provided in the communication terminal 10, a unique number of the communication subscriber identity module 15.

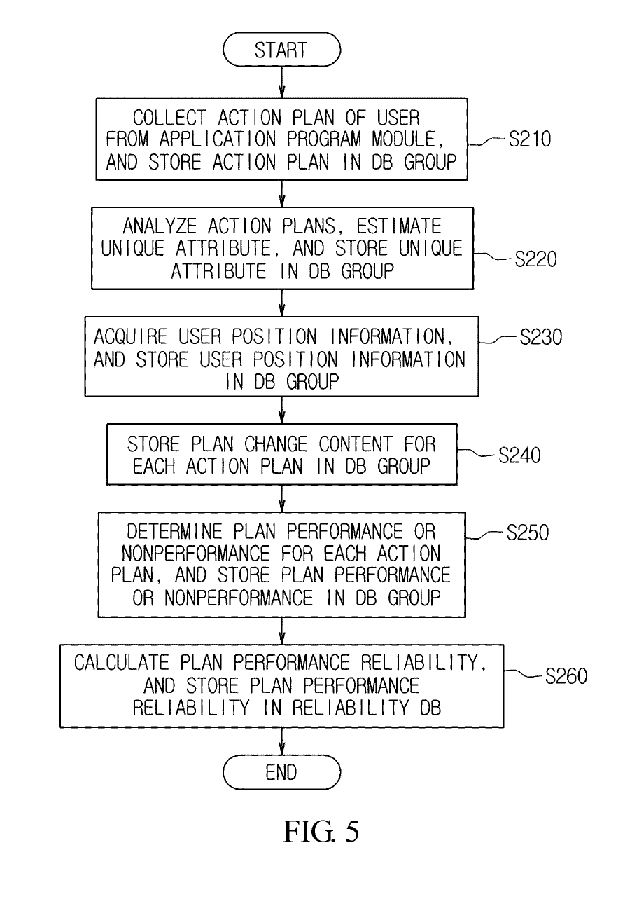

Hereinafter, S200 will be described in detail with reference to FIG. 5. First, when the server 30 is requested for action registration from the application program module 16, the server 30 collects the user certification information and the user action plans from the application program module 16, matches them with each other, and stores them in the action DB 21 of the DB group 20 (S210).

After S110, the server 30 analyzes the action plans, and recognizes the life pattern of the user corresponding to the user certification information, and estimates and generates the unique attribute of the user on the basis of the recognized life pattern of the user, and matches the unique attribute with the user certification information, and stores the unique attribute in the attribute DB 23 of the DB group 20 (S220).

In S220, the unique attribute may include a residence country, a residence region, an action region, an age, a sex, a birthday, a scholarship, a religion, an occupation, an exercise amount, favorite goods, interests, a social network, family, and the like of the user.

In S220. the server 30 may perform the repetitive analysis according to the date and time and the place of each action plan matched with the user certification information stored in the action DB 21, and recognize the life pattern of the user through the repetitive analysis, and estimate and generate the unique attribute of the user on the basis of the recognized life pattern. For example, the server 30 may recognize the life pattern of the user through the repetitive analysis about the date and time and the place of each action plane of the user, and estimate the unique attribute of the user such as family, schools, schoolmates, relatives, age, sex, workmates, and the like. The server 30 may recognize the life pattern of the user through the repetitive analysis about the date and time and the place of the action plan for each user, and estimate the unique attribute of the user such as a social network relationship such as family, schoolmates, and workmates, and the like.

After S220, the server 30 acquires the user certification information and the user position information for each time from the application program module 16, matches them with each other, stores them in the position DB 24 of the DB group 20 (S230).

In S230, the server 30 may recognize the position of the communication terminal 10 provided with the application program module 16 in real time through the mobile communication network constituting the communication network 40 and acquire the user position information for each time.

After S230, the server 30 receives the plan change content for each action plan matched with the user certification information stored in the action DB 21 of DB group 20 from the application program module 16 through S210, matches the received plan change content with the user certification information, and stores the plan change content in the plan performance DB 22 of the DB group 20 (S240).

After S240, the server 30 determines the plan performance or nonperformance of the user for each action plane matched with the user certification information stored in the action DB 21 of the DB group 20 through S210, matches the determined plan performance or nonperformance with the user certification information, and stores the plan performance or nonperformance in the plan performance DB 22 of the DB group 20 (S250).

In S250, when the plan performance determination reference included in the action plan is a specific place, the server 30 confirms whether or not the user is positioned at the time and place corresponding to the plan performance date and time and the specific place included in the action plan stored in the action DB 21 of DB group 20, using the user position information for each time matched with the user certification information stored in the position DB 24 of DB group 20, and determines the plan performance or nonperformance of the user for each action plan stored in the action DB 21 of DB group 20 according to the confirmation result. When the user is positioned at the time and place corresponding to the plan performance date and time and the specific place included in the action plan, the server 30 may further confirm whether or not a specific barcode or a specific QR code is scanned, a specific RF signal is read, or a specific infrared signal is sensed, in cooperation with a code scan application, an RF reader application, or an infrared sensor application provided in the communication terminal 10, and determine the plan performance or nonperformance of the user for each action plan according to the confirmation result.

In addition, in S250, when the plan performance determination reference included in the action plan is a URL/specific media watching channel of a specific web site, the server 30 may confirm whether or not a web browser/media player application accesses the URL/specific media watching channel of the specific web site at the time corresponding to the plan performance date and time included in the action plan stored in the action DB 21 in cooperation with the web browser/media player application provided in the communication terminal 10, and determine the plan performance or nonperformance of the user for the action plan stored in the action DB 21 according to the confirmation result.

After S250, the server 30 searches the plan performance or nonperformance and the plan change content of each action plan matched with the user certification information stored in the action DB 21, in the plan performance DB 22, and calculates the plan performance reliability of the user on the basis of the searched plan performance or nonperformance and the plan change content, and matches the calculated plan performance reliability with the user certification information, and stores the calculated plan performance reliability in the reliability DB 25 (S260).

The plan performance reliability in S260 may include a plan performance ratio and a plan change ratio. In this case, the plan performance ratio and the plan change ratio may be calculated for a time unit such as year, month, week, and date.

After S200, when the server 30 is requested for subscriber certification from the application program module 16 (S300), the server 30 performs a subscriber certification procedure for confirming whether or not the user of the application program module 16 requesting the subscriber certification is a subscriber (S400).

In S400, the server 30 acquires a plurality of action plans from the application program module 16 requesting the subscriber certification, and searches the user certification information commonly matched with the acquired action plans, in the action DB 21, and determines that it succeeds in the subscriber certification when the single user certification information is detected as the search result, and reports the success in the subscriber certification to the application program module 16, and designates the detected single user certification information as the user existing certification information which has been used by the user of the application program module 16.

S400 will be described in detail as follows. The server 30 acquires the action plan from the application program module 16 requesting the subscriber certification, searches the user certification information matched with the acquired action plan in the action DB 21, and then stores the searched user certification information in the internal memory area. Thereafter, the server 30 confirms whether or not the number of user certification information stored in the internal memory area is single, and additionally acquires the action plan from the application program module 16 when the number of user certification information is not single, and searches the user certification information matched with the additionally acquired action plan in the action DB 21 of the DB group, and then deletes all user certification information except the user certification information which is identical with the searched user certification information, from the internal memory area. Meanwhile, when the number of user certification information stored in the internal memory area is single, the server 30 designates the single user certification information stored in the internal memory area as the user existing certification information and changes the user existing certification information designated in the DB group 20 to the user certification information acquired from the application program module 16.

Meanwhile, in S400, the server 30 acquires a plurality of action plans from the application program module 16 requesting the subscriber certification, and searches the user certification information commonly matched with the acquired action plans, in the action DB 21, and determines that it fails in the subscriber certification when the single user certification information is not detected as the search result, and reports the failure in the subscriber certification to the application program module 16 requesting the subscriber certification.

After S400, when the server 30 is requested for the target user search from the application program module 16 (S500), the server 30 requests the application program module 16 for payment, and performs a payment procedure with the application program module 16. When the payment procedure is completed, the server 30 permits the target user search in the DB group 20 (S600).

After S600, when the target search option is set by the input of the user through the target searching UI, the application program module 16 searches users satisfying the set target search option in the DB group 20, and displays the number or a list of searched users through the target searching UI (S700).

In S700, the target search option may include a unique attribute, an action plan, plan performance reliability, and the like of the user.

In S700, the application program module 16 may classify and search the users for categories according to the target search option.

For example, in S700, when the target search option is set, the application program module 16 may search user certification information satisfying the set target search option, in the DB group 20, and display the number of searched user certification information as the number of users through the target search UI. In Step S700, when the target search option is set, the application program module 16 may search the user certification information satisfying the set target search option in the DB group 20, encode the searched user certification information, convert it into a user identity code, and display a list of the converted user identity code as a list of the user through the target searching UI.

In addition, after S700, when any one user is selected by the input of the user for detailed search, from the list of the users displayed through the target searching UI, the application program module 16 performs the search of the DB group 20 using the user certification information corresponding to the selected user, and searches the unique attribute of the user, the plan performance reliability, the action plans, the plan performance or nonperformance for each action plan, the plan change content, and the user feeling state, the user physical state, and the external environmental state of the plan performance date and the plan change date for each action plan, and displays the search result through the target searching UI.

In this case, for example, the application program module 16 may sort the action plans on the basis of the plan performance or nonperformance and the plan change content by the input of the user through the target searching UI, and display the action plans through the target searching UI. In addition, the application program module 16 may classify the displayed action plans on the basis of at least any one of the user feeling state, the user physical state, and environmental state of the plan performance date and the plan change date, and display the action plans through the target searching UI.

In addition, after S700, the application program module 16 may select the user selected by the input of the user through the target searching UI as a target user for contents distribution, from the list of the users displayed through the target searching UI.

Furthermore, after S200, when the server 30 is requested for action download from the application program module 16, the server 30 performs a subscriber certification procedure for confirming whether or not the user of the application program module 16 is a subscriber, through S400. When it succeeds in the subscriber certification, the server 30 acquires the user certification information from the application program module 16, and searches the action plans matched with the acquired user certification information in the action DB 21. The server 30 stores the action plans searched in the application program module 16.

The user data service system and method for the personalized contents providing service disclosed herein are not limited to the embodiment described above, and may be variously modified within the scope allowed by the technical concept of the present disclosure.

### INDUSTRIAL APPLICABILITY

The present invention has industrial applicability for providing a system and method for providing user information for a customized content provision service which enables a content distributor to collect action plans of the past, present, and future established by users and to use the collected action plans during a search for a target user.

1. A user data service system for a personalized contents providing service comprising a communication terminal,
wherein the communication terminal provides a DB group in a server with user certification information of a user of the communication terminal, action plans of the user and plan change content about each action plan
wherein the communication terminal comprises an application program module, comprising:
an action storing unit for storing the action plans of the user;
a memory unit for memorizing plan change content about each action plan;
a certification unit for performing a subscriber certification procedure in a relationship with the server by requesting the server for subscriber certification about the user;
a payment unit for performing a payment procedure according to a request of payment from the server after completion of a certification procedure and being permitted for target user search; and
a search unit for transmitting options of the target user search set by the user to the server, receiving a list of users including at least one user certification information satisfying the options and deciding a user selected in the list of users by the user as a target user for contents distribution.

2. The user data service system for the personalized contents providing service according to claim 1, further comprising the server for collecting the user certification information and the action plans of the user through the communication terminal, recognizing a life pattern of the user through repetitive analysis relating to date, time and place of each action plan matched with the user certification information stored in the DB group, generating a unique attribute of the user on the basis of the recognized life pattern and storing the unique attribute and the action plans of the user matching with the user certification information in the DB group.

3. The user data service system for the personalized contents providing service according to claim 2, wherein the server confirms plan performance date and plan performance change date about each action plan using whether or not the each action plan is performed and the plan change content of each action plan matched with the user certification information stored in the DB group, acquires at least any one of a user feeling state, a user physical state, and an eternal environmental state of the plan performance date and the plan change date about each confirmed action plan in cooperation with the application program module, and matches the acquired item with the user certification information and is stored in the DB group.

4. The user data service system for the personalized contents providing service according to claim 3, wherein the application program module further comprises:
a state storing unit for acquiring and storing at least one of the user feeling state, the user physical state, and the external environmental state for each date.

5. The user data service system for the personalized contents providing service according to claim 4, wherein the server analyzes the user biorhythm for each date using a birthday of the user among the unique attribute of the user according to a request of the application program module, and provides the analyzed user biorhythm to the application program module as the user physical state.

6. The user data service system for the personalized contents providing service according to claim 1, wherein the action plan includes plan performance date and time, a plan performance determination standard, and a plan content.

7. The user data service system for the personalized contents providing service according to claim 1, wherein the user certification information includes at least one of a production serial number of the communication terminal, a unique number (application identification) of the application program module provided in the communication terminal, and a unique number of a communication subscriber identifying module.

8. The user data service system for the personalized contents providing service according to claim 2, wherein the unique attribute includes a user profile excluding the personal data.

9. A user data service method for a personalized contents providing service, comprising:
(a) storing, by a server, user certification information and action plans of a user in a DB group included in the server, the user certification information and the action plans of the user are collected from an application program module provided in a communication terminal and matched with each other;
(b) storing in the DB group, by the server, plan change content about the each action plan matched with the user certification information, the plan change content is provided from the application program module;
(c) receiving, by the server, a request of subscriber certification from the application program module and performing certification procedure by determining whether or not the user which the subscriber certification is requested about is a subscriber;
(d) performing, by the server, a payment procedure together with the application program module responsive to a request of target user search from the application program module and permitting the target user search of the application program module when the payment procedure is complete; and
(e) providing the application program module with at least one user certification information satisfying options of the target user search inputted by the application program module in order to select a target user for contents distribution.

10. The user data service method for the personalized contents providing service according to claim 9, wherein the step of (a) comprises: providing a push notice for inducing an input of the action plans through the communication terminal in the application program module, for each irregular or regular time and place.

11. The user data service method for the personalized contents providing service according to claim 9, wherein the step of (c) comprises:
a first step of acquiring, by the server, a plurality of action plans from the application program module requesting the subscriber certification;
a second step of searching the user certification information commonly matched with the action plans acquired in the first step, in the DB group;
a third step of determining that it succeeds in the subscriber certification, and reporting the success in the subscriber certification to the application program module requesting the subscriber certification, when single user certification information is detected as the searching result in the second step;
a fourth step of designating the detected single user certification information as a user existing certification information used by the existing user of the application program module requesting the subscriber certification when the single user certification information is detected as the searching result in the second step; and
a fifth step of determining that it fails in the subscriber certification, and reporting the failure in the subscriber certification to the application program module requesting the subscriber certification, when the single user certification information is not detected as the searching result in the second step.

12. The user data service method for the personalized contents providing service according to claim 9, wherein the step of (c) comprises:
a first step of acquiring, by the server, an action plan from the application program module requesting the subscriber certification;
a second of step searching the user certification information matched with the action plan acquired in the first step, in the DB group;
a third step of storing, by the server, the user certification information searched in the second step in an internal memory area;
a fourth step of confirming whether or not the number of user certification information stored in the internal memory area is single;
a fifth step of designating the single user certification information stored in the internal memory area, as the user existing certification information, when the number of the user certification information is single as the confirmation result in the fourth step; and
a sixth step of changing the user certification information stored in the DB group, designated as the user existing certification information, to the user certification information acquired from the application program module requesting the subscriber certification.

13. The user data service method for the personalized contents providing service according to claim 12, wherein the step of (c) comprises:
a seventh step of adding, by server, the action plan from the application program module requesting the subscriber certification when the number of user certification information is not single as the confirmation result in the fourth step;
a eighth step of searching the user certification information matched with the action plan additionally acquired in the seventh step, in the DB group; and
a ninth step of deleting all user certification information except the user certification information which is identical with the user certification information searched in the eighth step, from the internal memory area.

14-15. (canceled)

16. The user data service method for the personalized contents providing service according to claim 9, further comprising:
(f) after the step of (b), confirming, by the server, plan performance date and plan performance change date about each action plan using whether or not the each action plan is performed and the plan change content of each action plan matched with the user certification information stored in the DB group, acquiring at least any one of a user feeling state, a user physical state, and an eternal environmental state of the plan performance date and the plan change date about each confirmed action plan in cooperation with the application program module, and matching the acquired item with the user certification information and is stored in the DB group.

17. The user data service system for the personalized contents providing service according to claim 2, wherein the application program module further comprises a determination unit for confirming whether or not a position and time which the user is located at correspond to plan performance time and a specific position included in the action plans stored in the DB group by using user information, and determining whether or not the each action plan is performed.

18. The user data service system for the personalized contents providing service according to claim 17, wherein the search unit transmits the options of the target user search set by the user to the server, receives at least one user certification information satisfying the options, converts the each user certification information into a user identity code representing sequence and providing a list of users, selects a user in the list of users for contents distribution by the user's input, transmits information about the selected user to the server and provides as a target user information the unique attribute, the action plans, information about whether or not the each action plan is performed, the plan change content and the plan performance reliability of the selected user which are received from the server.

19. The user data service method for the personalized contents providing service according to claim 9, further comprising:
(g) after the step of (a), confirming, by the server, whether or not a position and time which the user is located at correspond to plan performance time and a specific position included in the action plans stored in the DB group by using user information obtained from the application program module, and determining whether or not the each action plan is performed; and
(h) calculating, by the server, plan performance reliability of the user on the basis of whether or not the each action plan is performed and the plan change content and storing the plan performance reliability in the DB group.

20. The user data service method for the personalized contents providing service according to claim 19, further comprising:
(i) after the step of (a), storing, by the server, a unique attribute of the user in the DB group, the unique attribute of the user is generated through analysis of the action plans of the user stored in the DB group and matched to the user certification information by the server;
wherein the step of (e) comprises:
(e-1) receiving, by the server, the options of the target user search from the application program module;
(e-2) providing, by the server, the application program module with a list of users including user certification information satisfying the options of the target user search; and
(e-3) receiving, by the server, information related to a user selected in the list of users from the application program module and providing the application program module with the unique attribute, the action plans, information about whether or not the each action plan is performed, the plan change content and the plan performance reliability of the selected user as a target user.

21. The user data service method for the personalized contents providing service according to claim 19, wherein the step of (g) comprises:
confirming whether a specific barcode or a specific QR code is scanned, a specific RF signal is read, or a specific infrared signal is sensed, in cooperation with a specific application provided in the communication terminal, when the user is positioned at the time and place corresponding to the plan performance date, time, and place included in the action plan, determining the plan performance or nonperformance of the user for the action plan according to the confirmation result.

22. The user data service method for the personalized contents providing service according to claim 19, wherein the step of (g) comprises:
confirming whether or not a specific application provided in the communication terminal accesses a URL/specific media watching channel of a specific web site at the time corresponding to the plan performance date and time included in the action plan stored in the DB group, and determining the plan performance or nonperformance of the user for the action plan according to the confirmation result.
